(19) United States
(12) Patent Application Publication
(10) Pub. No.: US 2024/0187172 A1
(43) Pub. Date: Jun. 6, 2024

(54) SINGLE TRP AND MULTIPLE TRP DYNAMIC SWITCHING FOR SINGLE DCI BASED PUSCH TRANSMISSIONS

(71) Applicant: Intel Corporation, Santa Clara, CA (US)

(72) Inventors: Alexei Davydov, Nizhny Novgorod (RU); Bishwarup Mondal, San Ramon, CA (US); Dong Han, Sunnyvale, CA (US)

(21) Appl. No.: 18/549,805

(22) PCT Filed: May 3, 2022
(86) PCT No.: PCT/US2022/027427

§ 371 Date: Sep. 8, 2023

Related U.S. Application Data
(60) Provisional application No. 63/186,751, filed on May 10, 2021.

(51) Int. Cl. H04L 5/00; H04L 1/00; H04W 72/044; H04W 72/1273

(52) U.S. Cl. CPC H04L 5/0048; H04L 1/0013; H04W 72/046; H04W 72/1273

(57) ABSTRACT

Various embodiments herein relate to a technique to be performed by a user equipment (UE) in a cellular network. The technique may include identifying, in a downlink control information (DCI) received from a first transmission and reception point (TRP), an indication of whether the UE is to operate in accordance with a single-TRP physical uplink shared channel (PUSCH) mode or a multi-TRP PUSCH mode: identifying, based on the indication, one or more resources for PUSCH transmission; and transmitting, based on the indication and the one or more resources, a first repetition of the PUSCH transmission and a second repetition of the PUSCH transmission. Other embodiments may be described and/or claimed.

### CROSS REFERENCE TO RELATED APPLICATION

The present application claims priority to U.S. Provisional Patent Application No. 63/186,751, which was filed May 10, 2021.

### FIELD

Various embodiments generally may relate to the field of wireless communications. For example, some embodiments may relate to single transmission and reception point (TRP) and multiple TRP dynamic switching for single downlink control information (DCI)-based physical uplink shared channel (PUSCH) transmissions.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of single-DCI based PUSCH repetition, in accordance with various embodiments.

FIG. 2 illustrates an example of a medium access control (MAC) control element (CE) for use in a sounding reference signal (SRS) spatial relation indication, in accordance with various embodiments.

FIG. 3 indicates an example of a process to be used by a user equipment (UE), in accordance with various embodiments.

FIG. 4 indicates an example of a process to be used by a TRP, in accordance with various embodiments.

FIG. 5 schematically illustrates a wireless network in accordance with various embodiments.

FIG. 6 schematically illustrates components of a wireless network in accordance with various embodiments.

FIG. 7 is a block diagram illustrating components, according to some example embodiments, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

The third generation partnership project (3GPP) release-17 (Rel-17) fifth generation (5G)/new radio (NR) system may support multi-TRP transmission schemes in the uplink (UL). In particular, to increase robustness of the transmission to potential blockage of the channel, a user equipment (UE) may transmit a signal targeting two or more TRPs.

In the legacy 3GPP specifications, PUSCH repetition is only supported based on a single-TRP, which may be a bottleneck for the reliability of the whole system when multi-TRP based physical downlink shared channel (PDSCH) repetition is adopted. Especially in frequency-range 2 (FR2), which may correspond to between approximately 24250 Megahertz (MHz) and 52600 MHz, when a link between a UE and a TRP is affected by blockage, the PUSCH repetition based on single-TRP may not be reliable anymore. However, when repetitive transmissions are performed across multiple links between a UE and multiple TRPs, such repetition may be more reliable due to macro diversity, especially when the blockage exists. Hence multi-TRP based PUCCH/PUSCH repetition may be desirable.

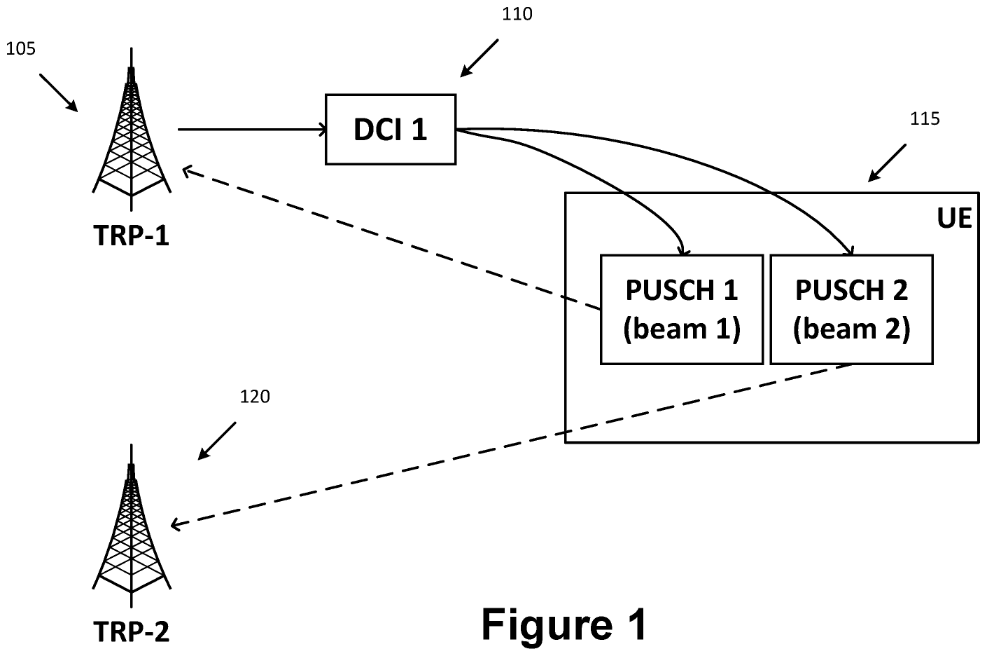

To support multi-TRP based PUSCH repetition, single-DCI based (e.g., as shown in FIG. 1) can be used. In particular, a single-DCI based scheme may schedule PUSCH repetitions by one DCI that either be transmitted through one TRP or multiple TRPs. More specifically, TRP-1 105 may transmit DCI-1 110 to a UE 115. Based on DCI-1 110, the UE 115 may transmit repetitions of the PUSCH (labelled as PUSCH 1 and PUSCH 2) to TRP-1 105 and TRP-2 120 as shown in FIG. 1. It will be noted that the above is just one example and, in other embodiments, PUSCH 1 may be transmitted to TRP-2 120, and PUSCH 2 may be transmitted to TRP-1 105.

Comparing with single-TRP based PUSCH transmission, multi-TRP based PUSCH repetition may provide more diversity and has more flexibility. For instance, 2-TRP based PUSCH repetition (e.g., as shown in FIG. 1) may allow the two PUSCHs to be scheduled with different modulation coding schemes (MCSs), resource allocations, pre-coding matrix indicators (PMI), etc. Generally single-TRP based transmission may be used in legacy NR networks, and so it may be desirable for the NR network to support dynamic switching between single-TRP (e.g., sTRP or 1-TRP) and multi-TRP (e.g., mTRP or 2-TRP) PUSCH transmissions.

In legacy network implementations, dynamic switching between 1-TRP and 2-TRP PUSCH transmission has not been supported. Therefore, various embodiments herein relate to techniques for dynamic switching between 1-TRP and 2-TRP using a field in DCI to indicate dynamic switching between sTRP and mTRP operation. The embodiments may increase the flexibility of the PUSCH transmission.

Specifically, in multi-TRP PUSCH transmissions, the UE (e.g., UE 115) may transmit the same information in multiple PUSCH repetitions to multiple TRPs with different beams to achieve spatial diversity, for example as shown in FIG. 1. For example, PUSCH repetition 1 and repetition 2 can be transmitted to TRP-1 and TRP-2 with beam 1 and beam 2, respectively as shown in FIG. 1.

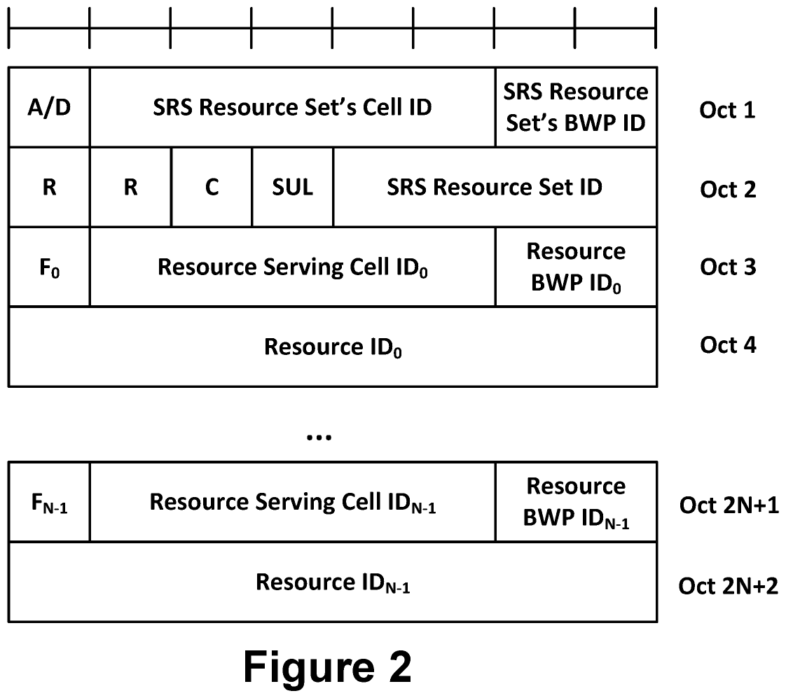

In legacy specifications, the SRS resource indicator (SRI) field in the DCI may only indicate the SRS resource(s) for a single PUSCH transmission towards a TRP. For single-TRP PUSCH transmission in the legacy 3GPP specifications, the UE's SRS index may be indicated by the SRI in the DCI, and the correspondence between SRS index and the downlink (DL) reference signal resource may be indicated by a MAC CE (e.g., as shown by the MAC CE in FIG. 2).

Thus, if the multi-TRP PUSCH repetitions are scheduled by a single DCI, and it may be desirable to redesign the DCI fields that schedule the PUSCH repetitions to support the indication of two PUSCH transmission beams.

On the other hand, it may be desirable for the redesigned DCI to support multiple PUSCH beams to be backward compatible, e.g., it should also support the indication of a single PUSCH beam for single-TRP PUSCH transmission. In the legacy 3GPP specifications, each TRP may be configured with an SRS resource set. A UE may be configured with SRS resource set 0 and SRS resource set 1 that is implicitly associated with TRP-0 and TRP-1, respectively. Within an SRS resource set, there may be multiple SRS resources identified by the SRI.

In embodiments, scheduling PUSCH repetitions towards two TRPs may be based on one or more of the following: 1) two SRI fields, each field corresponding to an SRS resource set; and 2) two transmit precoding matrix indicators (TPMIs) for two PUSCH repetitions, respectively. Additionally, embodiments may relate to a new DCI field to indicate the sTRP and mTRP operation. The new DCI field may be either 1-bit or 2-bit length. Thus, for single-DCI based multi-TRP PUSCH repetition, embodiments herein may include or be based on the following options to indicate the dynamic switching between sTRP and mTRP operation:

Option-1, 1-bit sTRP/mTRP Switching Field.

In this option, 1 bit in DCI is used to indicate the sTRP and mTRP operation dynamically. Particularly, for a codebook (CB)-based scheme, if DCI indicates 0, the first SRI field corresponds to SRS resource set 0 and the first precoder information and layer (PINL) field, which may include or relate to TPMI information, is applied. If DCI indicates 1, the first SRI field corresponds to SRS resource set 0 and the second SRI field corresponds to SRS resource set 1, and the first and second PINL (which may relate to TPMI) fields are applied respectively, which is shown in Table 1, below.

For a non-codebook (NCB)-based scheme, if DCI indicates 0, the first SRI field corresponding to SRS resource set 0 is used. If DCI indicates 1, the first SRI field corresponds to SRS resource set 0 and the second SRI field corresponds to SRS resource set 1 are used, which is shown in Table 2, below.

TABLE 1
1-bit sTRP/mTRP switching field design for CB-based scheme

| sTRP/mTRP | SRI field/SRS- | Corre- | |
|---|---|---|---|
| switching | SpatialRelationInfo | sponding | |
| field index | association with | PINL | |
| (CB-based) | SRS resource set | field | Power control |
| 0 | 1^{st} SRI field associated | 1^{st} | first SRI-PUSCH- |
| | with first SRS resource | PINL | PowerControl |
| | set applied to all | field | applied to all |
| | PUSCH Tx occasions | | PUSCH Tx occasions |
| 1 | 1^{st} SRI field (first SRS | 1^{st} and | first and second SRI- |
| | resource set) and 2^{nd} | 2^{nd} | PUSCH-PowerControl |
| | SRI field (second SRS | PINL | applied to first and |
| | resource set) applied to | fields | second PUSCH Tx |
| | first and second | | occasions respectively |
| | PUSCH Tx occasions | | |
| | respectively | | |

TABLE 2
1-bit sTRP/mTRP switching field design for NCB-based scheme

| sTRP/mTRP | SRI field/SRS- | |
|---|---|---|
| switching | SpatialRelationInfo | |
| field index | association with | |
| (NCB-based) | SRS resource set | Power control |
| 0 | 1^{st} SRI field associated | first SRI-PUSCH- |
| | with first SRS resource | PowerControl applied |
| | set applied to all | to all PUSCH Tx |
| | PUSCH Tx occasions | occasions |
| 1 | 1^{st} SRI field (first SRS | first and second SRI- |
| | resource set) and2^{nd} | PUSCH-PowerControl |
| | SRI field (second SRS | applied to first and |
| | resource set) applied to | second PUSCH Tx |
| | first and second PUSCH | occasions respectively |
| | Tx occasions respectively | |

Option-2, 2-bit sTRP/mTRP Switching Field.

In this option, 2 bits in DCI are used to indicate the sTRP and mTRP operation dynamically. Particularly, for a CB-based scheme, if DCI indicates 0 or 1, sTRP operation is used, the indices 0 and 1 indicates the first and second PINL (which may relate to TPMI) and SRI fields corresponding to the SRS resource set 0 and SRS resource set 1 respectively, as shown in Table 3, below. If DCI indicates 2 or 3, mTRP operation is used, index 2 indicates both the SRI and PINL (which may relate to TPMI) fields, where the first SRI field corresponds to SRS resource set 0 and the second SRI field corresponds to the SRS resource set 1; index 3 indicates both the SRI and PINL (which may relate to TPMI) fields, where the first SRI field corresponds to SRS resource set 1 and the second SRI field corresponds to the SRS resource set 0, as shown in Table 3.

For NCB-based scheme, if DCI indicates 0 or 1, sTRP operation is used, the indices 0 and 1 indicates the first (and second SRI) fields corresponding to the SRS resource set 0 and SRS resource set 1 respectively, as shown in Table 4-1 and Table 4-2, below. If DCI indicates 2 or 3, mTRP operation is used, index 2 indicates both the SRI and PINL (TPMI) fields, where the first SRI field corresponds to SRS resource set 0 and the second SRI field corresponds to the SRS resource set 1; index 3 indicates both the SRI and PINL (TPMI) fields, where the first SRI field corresponds to SRS resource set 1 and the second SRI field corresponds to the SRS resource set 0, as shown in Table 4-1 and Table 4-2.

Note that by using 2-bit sTRP/mTRP switching field design, the reordering of TRP1/TPR2 SRS resource set in mTRP operation, and the selection of TRP1 and TRP2 in sTRP operation may be supported.

TABLE 3
2-bit sTRP/mTRP switching field design for CB-based scheme

| sTRP/mTRP | SRI field/SRS- | Corre- | |
|---|---|---|---|
| switching | SpatialRelationInfo | sponding | |
| field index | association with | PINL | |
| (CB-based) | SRS resource set | field | Power control |
| 0 | 1^{st} SRI field (first SRS | 1^{st} | first SRI-PUSCH- |
| | resource set) applied | PINL | PowerControl |
| | to all PUSCH Tx | field | applied to all |
| | occasions | | PUSCH Tx |
| | | | occasions |
| 1 | 2^{nd} SRI field (second | 2^{nd} | second SRI-PUSCH- |
| | SRS resource set) | PINL | PowerControl |
| | applied to all PUSCH | field | applied to all |
| | Tx occasions | | PUSCH Tx occasions |
| 2 | 1^{st} SRI field (first SRS | 1^{st} and | first and second SRI- |
| | resource set), applied | 2^{nd} | PUSCH-PowerControl |
| | to first PUSCH Tx | PINL | applied to first and |
| | occasions | fields | second PUSCH Tx |
| | 2^{nd} SRI field (second | | occasions respectively |
| | SRS resource set) | | |
| | applied to second | | |
| | PUSCH Tx occasions | | |
| 3 | 1^{st} SRI field (first SRS | 1^{st} and | first and second SRI- |
| | resource set), applied | 2^{nd} | PUSCH-PowerControl |
| | to second PUSCH Tx | PINL | applied to second and |
| | occasions | fields | first PUSCH Tx |
| | 2^{nd} SRI field (second | | occasions respectively |
| | SRS resource set) | | |
| | applied to second | | |
| | PUSCH Tx occasions | | |

TABLE 4-1
2-bit sTRP/mTRP switching field design for NCB-based scheme
(index ‘1’ mapped to the 2^{nd} SRI field)

| sTRP/mTRP | SRI field/SRS- | |
|---|---|---|
| switching | SpatialRelationInfo | |
| field index | association with | |
| (NCB-based) | SRS resource set | Power control |
| 0 | 1^{st} SRI field (first SRS | first SRI-PUSCH- |
| | resource set) applied to | PowerControl applied to |
| | all PUSCH Tx occasions | all PUSCH Tx occasions |
| 1 | 2^{nd} SRI field (second SRS | second SRI-PUSCH- |
| | resource set) applied to | PowerControl applied to |
| | all PUSCH Tx occasions | all PUSCH Tx occasions |
| 2 | 1^{st} SRI field (first SRS | first and second SRI-PUSCH- |
| | resource set), applied to | PowerControl applied to first |
| | first PUSCH Tx occasions | and second PUSCH Tx |
| | 2^{nd} SRI field (second SRS | occasions respectively |
| | resource set) applied to | |
| | second PUSCH Tx | |
| | occasions | |
| 3 | 1^{st} SRI field (first SRS | first and second SRI-PUSCH- |
| | resource set), applied to | PowerControl applied to |
| | second PUSCH Tx | second and first PUSCH Tx |
| | occasions | occasions respectively |
| | 2^{nd} SRI field (second SRS | |
| | resource set) applied to | |
| | second PUSCH Tx | |
| | occasions | |

TABLE 4-2
2-bit sTRP/mTRP switching field design for NCB-based scheme
(index ‘1’ mapped to the 1^{st} SRI field)

| sTRP/mTRP | SRI field/SRS- | |
|---|---|---|
| switching | SpatialRelationInfo | |
| field index | association with | |
| (NCB-based) | SRS resource set | Power control |
| 0 | 1^{st} SRI field (first SRS | first SRI-PUSCH- |
| | resource set) applied to | PowerControl applied to |
| | all PUSCH Tx occasions | all PUSCH Tx occasions |
| 1 | 1^{st} SRI field (second SRS | second SRI-PUSCH- |
| | resource set) applied to | PowerControl applied to all |
| | all PUSCH Tx occasions | PUSCH Tx occasions |
| 2 | 1^{st} SRI field (first SRS | first and second SRI-PUSCH- |
| | resource set), applied to | PowerControl applied to first |
| | first PUSCH Tx occasions | and second PUSCH Tx |
| | 2^{nd} SRI field (second SRS | occasions respectively |
| | resource set) applied to | |
| | second PUSCH Tx | |
| | occasions | |
| 3 | 1^{st} SRI field (first SRS | first and second SRI-PUSCH- |
| | resource set), applied to | PowerControl applied to |
| | second PUSCH Tx | second and first PUSCH Tx |
| | occasions | occasions respectively |
| | 2^{nd} SRI field (second SRS | |
| | resource set) applied to | |
| | second PUSCH Tx | |
| | occasions | |

### Example Techniques

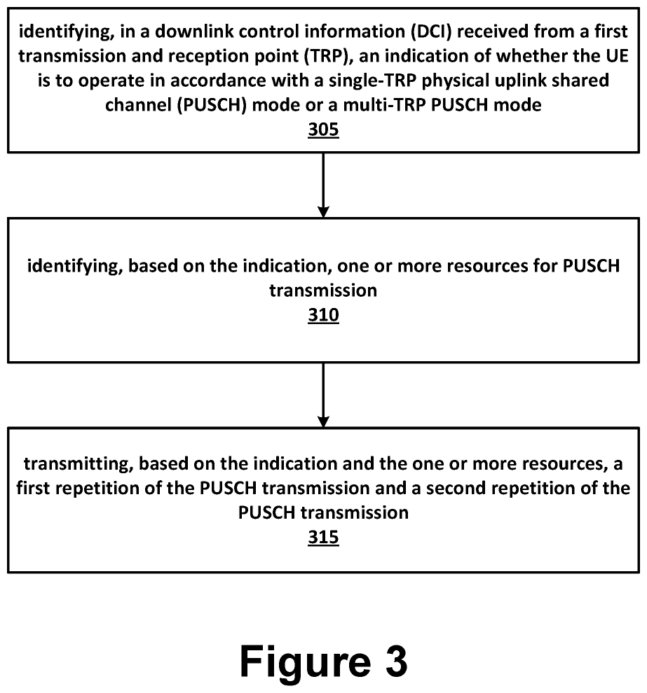

FIG. 3 indicates an example of a process to be used by a user equipment (UE), one or more elements of a UE, and/or an electronic device that includes a UE, in accordance with various embodiments. Specifically, the process may include identifying, at 305 in a downlink control information (DCI) received from a first transmission and reception point (TRP), an indication of whether the UE is to operate in accordance with a single-TRP physical uplink shared channel (PUSCH) mode or a multi-TRP PUSCH mode. For example, the single-TRP mode may be the sTRP mode and/or the 1-TRP mode described above. The multi-TRP mode may be the mTRP mode and/or the 2-TRP mode described above The process may further include identifying, at 310 based on the indication, one or more resources for PUSCH transmission. The process may further include transmitting, at 315 based on the indication and the one or more resources, a first repetition of the PUSCH transmission and a second repetition of the PUSCH transmission. For example, if the UE is in the single-TRP mode, the UE may transmit the first and second PUSCH repetitions to a single TRP. If the UE is in the multi-TRP mode, the UE may transmit the first PUSCH repetition to a first TRP and the second PUSCH repetition to a second TRP.

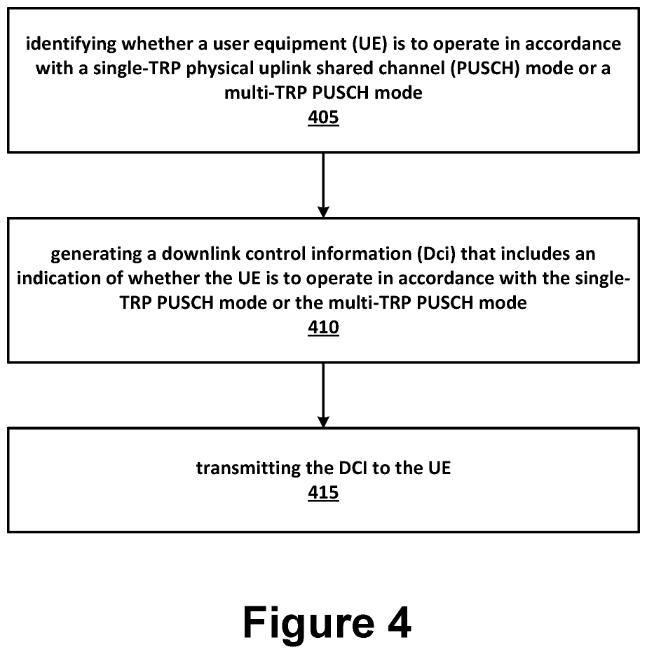

FIG. 4 indicates an example of a process to be used by a TRP, one or more elements of a TRP, and/or an electronic device that includes a TRP, in accordance with various embodiments. The process may include identifying, at 405, whether a user equipment (UE) is to operate in accordance with a single-TRP physical uplink shared channel (PUSCH) mode or a multi-TRP PUSCH mode (as described above, for example with respect to FIG. 3). The process may further include generating, at 410, a downlink control information (DCI) that includes an indication of whether the UE is to operate in accordance with the single-TRP PUSCH mode or the multi-TRP PUSCH mode. The process may further include transmitting, at 415, the DCI to the UE.

It will be noted that the embodiments of FIGS. 3 and 4 (and other embodiments described herein) are intended as example embodiments and other embodiments may vary. For example, other embodiments may have more or fewer elements than are depicted in FIGS. 3 and 4, elements that occur in a different order than depicted, etc. Other embodiments may vary.

### Systems and Implementations

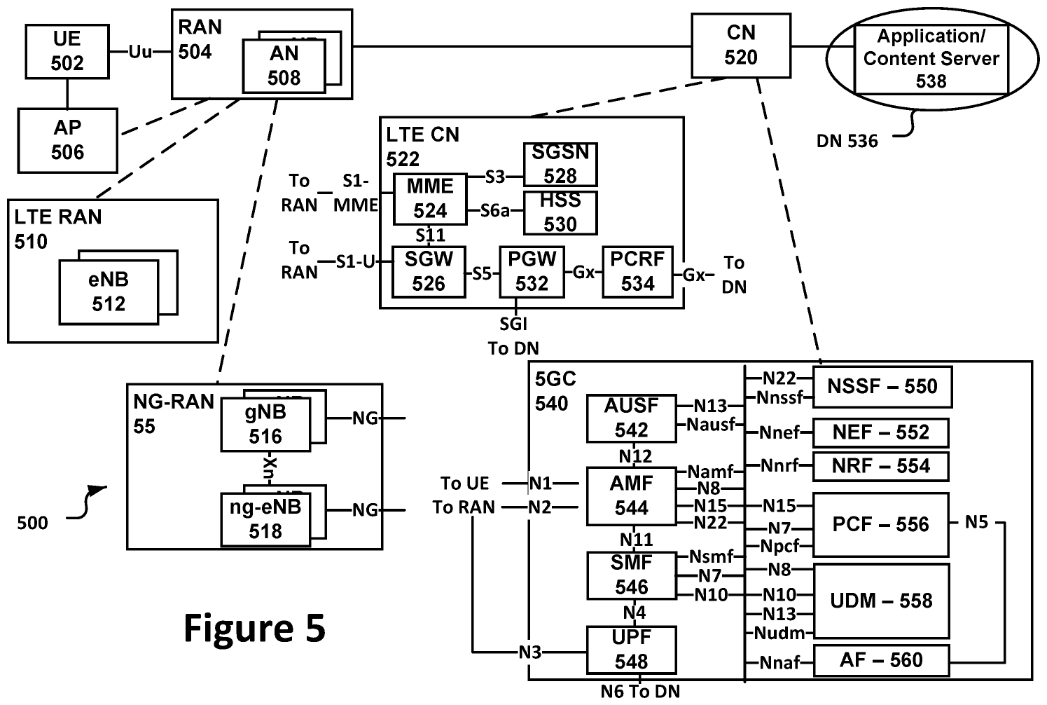

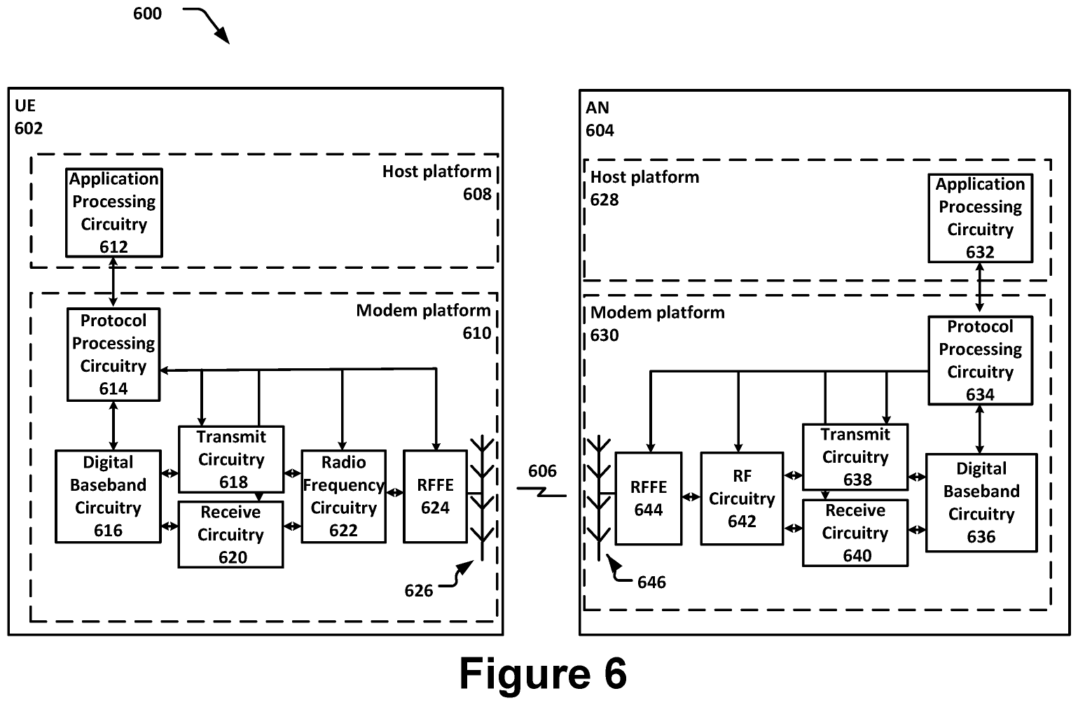

FIGS. 5-6 illustrate various systems, devices, and components that may implement aspects of disclosed embodiments.

FIG. 5 illustrates a network 500 in accordance with various embodiments. The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 802.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 504 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and LI protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface. In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN 514 and an AMF 544 (e.g., N2 interface). The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an SI interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network 536 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, and AF 560 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management, mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (N1) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 552 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR 221 to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re)selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mmWave or sub-6GHZ frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 616 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

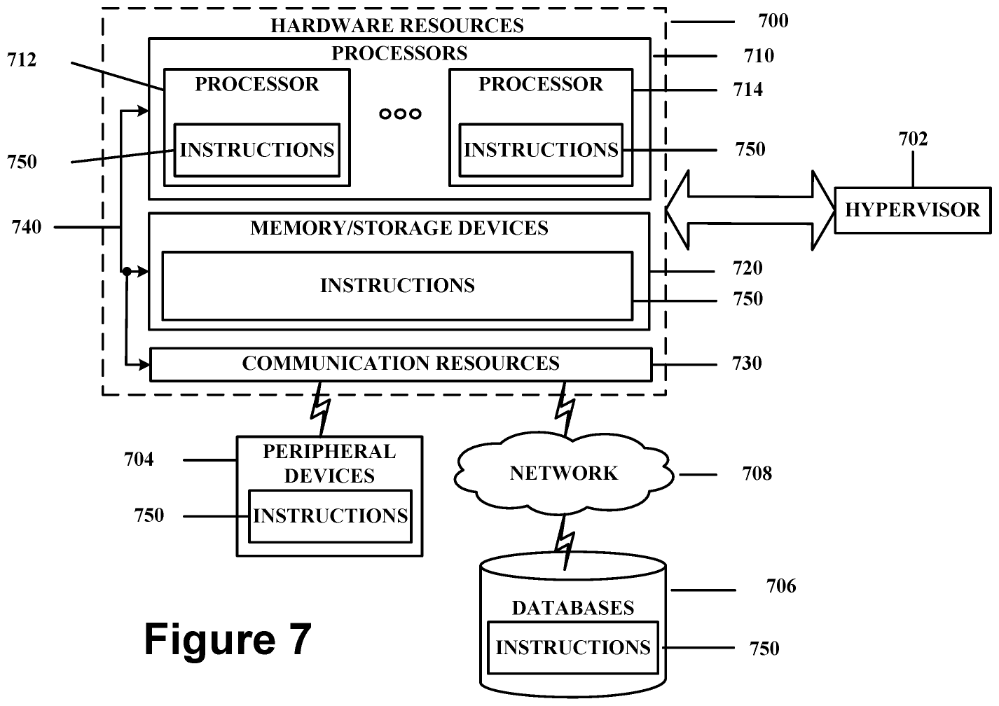

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of dynamic switching between 1-TRP and 2-TRP in single-DCI based PUSCH transmission by adding a new field in DCI.

Example 2 may include the method of example 1, and/or some other example herein, wherein the new field includes 1-bit sTRP/mTRP switching field design for CB-based scheme.

Example 3 may include the method of example 1, and/or some other example herein, wherein the new field includes 1-bit sTRP/mTRP switching field design for NCB-based scheme.

Example 4 may include the method of example 1, and/or some other example herein, wherein the new field includes 2-bit sTRP/mTRP switching field design for CB-based scheme.

Example 5 may include the method of example 1, and/or some other example herein, wherein the new field includes 2-bit sTRP/mTRP switching field design for NCB-based scheme.

Example 6 may include the method of example 4-5, and/or some other example herein, wherein the field further indicates selection of TRP1 and TRP2 in sTRP operation.

Example 7 may include the method of example 4-6, and/or some other example herein, wherein the field further indicates re-ordering TRP1/TPR2 SRS resource set in mTRP operation.

Example 8 may include a method to be performed by a user equipment (UE) in a cellular network, wherein the method comprises: identifying, in a downlink control information (DCI) received from a first transmission and reception point (TRP), an indication of whether the UE is to operate in accordance with a single-TRP physical uplink shared channel (PUSCH) mode or a multi-TRP PUSCH mode; identifying, based on the indication, one or more resources for PUSCH transmission; and transmitting, based on the indication and the one or more resources, a first repetition of the PUSCH transmission and a second repetition of the PUSCH transmission.

Example 9 may include the method of example 8, and/or some other example herein, wherein the one or more resources are further identified based on whether the UE is to operate in accordance with a codebook (CB)-based scheme or a non-codebook (NCB)-based scheme.

Example 10 may include the method of any of examples 8-9, and/or some other example herein, wherein the indication is a 1-bit indication or a 2-bit indication.

Example 11 may include the method of any of examples 8-10, and/or some other example herein, wherein, in single-TRP PUSCH mode, the method comprises transmitting the first repetition and the second repetition to the TRP or to transmit the first repetition and the second repetition to another TRP.

Example 12 may include the method of any of examples 8-11, and/or some other example herein, wherein, in multi-TRP PUSCH mode, the method comprises transmitting one of the first repetition and the second repetition to the TRP and transmitting the other of the first repetition and the second repetition to another TRP.

Example 13 may include the method of any of examples 8-12, and/or some other example herein, wherein the one or more resources include a SpatialRelationInfo parameter that is associated with a sounding reference signal (SRS) resource set to be used with at least one of the first repetition and the second repetition.

Example 14 may include the method of example 13, and/or some other example herein, wherein: if the UE is operating in accordance with the single-TRP PUSCH mode, a same SRS resource set is applied to the first repetition and the second repetition; and if the UE is operating in accordance with the multi-TRP PUSCH mode, a first SRS resource set is applied to one of the first repetition and the second repetition, and a second SRS resource set is applied to other of the first repetition and the second repetition.

Example 15 may include the method of any of examples 8-14, and/or some other example herein, wherein the one or more resources include a precoder information and layer (PINL) field that indicates a transmit precoding matrix indicator (TPMI) to be used with at least one of the first repetition and the second repetition.

Example 16 may include the method of example 15, and/or some other example herein, wherein: if the UE is operating in accordance with the single-TRP PUSCH mode, a same TPMI is applied to the first repetition and the second repetition; and if the UE is operating in accordance with the multi-TRP PUSCH mode, a first TPMI is applied to the first repetition and a second TPMI is applied to the second repetition.

Example 17 may include the method of any of examples 8-16, and/or some other example herein, wherein the one or more resources include a SRI-PUSCH-PowerControl field that indicates a power to be used for transmission of at least one of the first repetition and the second repetition.

Example 18 may include the method of example 16, and/or some other example herein, wherein: if the UE is operating in accordance with the single-TRP PUSCH mode, a same power is used for transmission of the first repetition and the second repetition; and if the UE is operating in accordance with the multi-TRP PUSCH mode, a first power is used for transmission of the first repetition and a second power is used for transmission of the second repetition.

Example 19 may include a method to be performed by a transmission and reception point (TRP) in a cellular network, wherein the method comprises: identifying whether a user equipment (UE) is to operate in accordance with a single-TRP physical uplink shared channel (PUSCH) mode or a multi-TRP PUSCH mode; generating a downlink control information (DCI) that includes an indication of whether the UE is to operate in accordance with the single-TRP PUSCH mode or the multi-TRP PUSCH mode; and transmitting the DCI to the UE.

Example 20 may include the method of example 19, and/or some other example herein, wherein the indication is a 1-bit indication or a 2-bit indication.

Example 21 may include the method of any of examples 19-20, and/or some other example herein, wherein, in single-TRP PUSCH mode, the UE is to transmit a first PUSCH repetition and a second PUSCH repetition to the TRP or transmit the first PUSCH repetition and the second PUSCH repetition to another TRP.

Example 22 may include the method of any of examples 19-21, and/or some other example herein, wherein, in multi-TRP PUSCH mode, the UE is to transmit one of a first PUSCH repetition and a second PUSCH repetition to the TRP, and transmit the other of the first PUSCH repetition and the second PUSCH repetition to another TRP.

Example 23 may include the method of any of examples 19-22, and/or some other example herein, wherein: if the UE is operating in accordance with the single-TRP PUSCH mode, the UE is to apply a same SRS resource set to a first PUSCH repetition and a second PUSCH repetition; and if the UE is operating in accordance with the multi-TRP PUSCH mode, the UE is to apply a first SRS resource set to one of the first PUSCH repetition and the second PUSCh repetition, and a second SRS resource set to the other of the first PUSCH repetition and the second PUSCH repetition.

Example 24 may include the method of any of examples 19-23, and/or some other example herein, wherein: if the UE is operating in accordance with the single-TRP PUSCH mode, the UE is to apply a same transmit precoding matrix indicator (TPMI) to a first PUSCH repetition and a second PUSCH repetition; and if the UE is operating in accordance with the multi-TRP PUSCH mode, the UE is to apply a first TPMI to the first PUSCH repetition and a second TPMI to the second PUSCH repetition.

Example 25 may include the method of any of examples 19-24, and/or some other example herein, wherein: if the UE is operating in accordance with the single-TRP PUSCH mode, a same power is used by the UE for transmission of a first PUSCH repetition and a second PUSCH repetition; and if the UE is operating in accordance with the multi-TRP PUSCH mode, a first power is used by the UE for transmission of the first PUSCH repetition and a second power is used for transmission of the second PUSCH repetition.

Example Z01 may include an apparatus comprising means to perform one or more elements of a method described in or related to any of examples 1-25, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example Z03 may include an apparatus comprising logic, modules, or circuitry to perform one or more elements of a method described in or related to any of examples 1-25, or any other method or process described herein.

Example Z04 may include a method, technique, or process as described in or related to any of examples 1-25, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example Z06 may include a signal as described in or related to any of examples 1-25, or portions or parts thereof.

Example Z07 may include a datagram, packet, frame, segment, protocol data unit (PDU), or message as described in or related to any of examples 1-25, or portions or parts thereof, or otherwise described in the present disclosure.

Example Z08 may include a signal encoded with data as described in or related to any of examples 1-25, or portions or parts thereof, or otherwise described in the present disclosure.

Example Z09 may include a signal encoded with a datagram, packet, frame, segment, protocol data unit (PDU), or message as described in or related to any of examples 1-25, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example Z11 may include a computer program comprising instructions, wherein execution of the program by a processing element is to cause the processing element to carry out the method, techniques, or process as described in or related to any of examples 1-25, or portions thereof.

Example Z12 may include a signal in a wireless network as shown and described herein. Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-Measurement TimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-20. (canceled)

21. A user equipment (UE) comprising:
memory to store a downlink control information (DCI) received from a first transmission and reception point (TRP); and
one or more processors to:
identify, in the DCI, an indication of whether the UE is to operate in accordance with a single-TRP physical uplink shared channel (PUSCH) mode or a multi-TRP PUSCH mode;
identify, based on the indication, one or more resources for PUSCH transmission; and
transmit, based on the indication and the one or more resources, a first repetition of the PUSCH transmission and a second repetition of the PUSCH transmission.

22. The UE of claim 21, wherein the one or more processors are further to identify the one or more resources based on whether the UE is to operate in accordance with a codebook (CB)-based scheme or a non-codebook (NCB)-based scheme.

33. The UE of claim 21, wherein the indication is a 2-bit indication.

24. The UE of claim 21, wherein, in single-TRP PUSCH mode, the one or more processors are to cause the UE to transmit the first repetition and the second repetition to the TRP or to transmit the first repetition and the second repetition to another TRP.

25. The UE of claim 21, wherein, in multi-TRP PUSCH mode, the one or more processors are to cause the UE to transmit one of the first repetition and the second repetition to the TRP and transmit the other of the first repetition and the second repetition to another TRP.

26. The UE of claim 21, wherein the one or more resources include a SpatialRelationInfo parameter that is associated with a sounding reference signal (SRS) resource set to be used with at least one of the first repetition and the second repetition.

27. The UE of claim 26, wherein:
if the UE is operating in accordance with the single-TRP PUSCH mode, a same SRS resource set is applied to the first repetition and the second repetition; and
if the UE is operating in accordance with the multi-TRP PUSCH mode, a first SRS resource set is applied to one of the first repetition and the second repetition, and a second SRS resource set is applied to the other of the first repetition and the second repetition.

28. The UE of claim 21, wherein the one or more resources include a precoder information and layer (PINL) field that indicates a transmit precoding matrix indicator (TPMI) to be used with at least one of the first repetition and the second repetition.

29. The UE of claim 28, wherein:
if the UE is operating in accordance with the single-TRP PUSCH mode, a same TPMI is applied to the first repetition and the second repetition; and
if the UE is operating in accordance with the multi-TRP PUSCH mode, a first TPMI is applied to the first repetition and a second TPMI is applied to the second repetition.

30. The UE of claim 21, wherein the one or more resources include a SRI-PUSCH-PowerControl field that indicates a power to be used for transmission of at least one of the first repetition and the second repetition.

31. The UE of claim 30, wherein:
if the UE is operating in accordance with the single-TRP PUSCH mode, a same power is used for transmission of the first repetition and the second repetition; and
if the UE is operating in accordance with the multi-TRP PUSCH mode, a first power is used for transmission of the first repetition and a second power is used for transmission of the second repetition.

32. One or more non-transitory computer-readable media comprising instructions that, upon execution of the instructions by one or more processors of a transmission and reception point (TRP) in a cellular network, are to cause the TRP to:
identify whether a user equipment (UE) is to operate in accordance with a single-TRP physical uplink shared channel (PUSCH) mode or a multi-TRP PUSCH mode;
generate a downlink control information (DCI) that includes an indication of whether the UE is to operate in accordance with the single-TRP PUSCH mode or the multi-TRP PUSCH mode; and
transmit the DCI to the UE.

33. The one or more non-transitory computer-readable media of claim 32, wherein the indication is a 2-bit indication.

34. The one or more non-transitory computer-readable media of claim 32, wherein, in single-TRP PUSCH mode, the UE is to transmit a first PUSCH repetition and a second PUSCH repetition to the TRP or to transmit the first PUSCH repetition and the second PUSCH repetition to another TRP.

35. The one or more non-transitory computer-readable media of claim 32, wherein, in multi-TRP PUSCH mode, the UE is to transmit one of a first PUSCH repetition and a second PUSCH repetition to the TRP, and transmit the other of the first PUSCH repetition and the second PUSCH repetition to another TRP.

36. The one or more non-transitory computer-readable media of claim 32, wherein:
if the UE is operating in accordance with the single-TRP PUSCH mode, the UE is to apply a same SRS resource set to a first PUSCH repetition and a second PUSCH repetition; and
if the UE is operating in accordance with the multi-TRP PUSCH mode, the UE is to apply a first SRS resource set to one of the first PUSCH repetition and the second PUSCH repetition, and a second SRS resource set to the other of the first PUSCH repetition and the second PUSCH repetition.

37. The one or more non-transitory computer-readable media of claim 32, wherein:
if the UE is operating in accordance with the single-TRP PUSCH mode, the UE is to apply a same transmit precoding matrix indicator (TPMI) to a first PUSCH repetition and a second PUSCH repetition; and
if the UE is operating in accordance with the multi-TRP PUSCH mode, the UE is to apply a first TPMI to the first PUSCH repetition and a second TPMI to the second PUSCH repetition.

38. The one or more non-transitory computer-readable media of claim 32, wherein:
if the UE is operating in accordance with the single-TRP PUSCH mode, a same power is used by the UE for transmission of a first PUSCH repetition and a second PUSCH repetition; and
if the UE is operating in accordance with the multi-TRP PUSCH mode, a first power is used by the UE for transmission of the first PUSCH repetition and a second power is used for transmission of the second PUSCH repetition.

39. A user equipment (UE) comprising:
one or more processors; and
one or more non-transitory computer-readable media comprising instructions that, upon execution of the instructions by the one or more processors, are to cause the UE to:
identify, in a downlink control information (DCI) received from a first transmission and reception point (TRP), an indication of whether the UE is to operate in accordance with a single-TRP physical uplink shared channel (PUSCH) mode or a multi-TRP PUSCH mode;
identify, based on the indication, one or more resources for PUSCH transmission; and
transmit, based on the indication and the one or more resources, a first repetition of the PUSCH transmission and a second repetition of the PUSCH transmission.

40. The UE of claim 39, wherein the instructions are further to identify the one or more resources based on whether the UE is to operate in accordance with a codebook (CB)-based scheme or a non-codebook (NCB)-based scheme.
